(19) United States
(12) Patent Application Publication
(10) Pub. No.: US 2026/0359530 A1
(43) Pub. Date: Nov. 12, 2026

(54) MULTI-OBJECTIVE SEGMENTED OPTIMIZATION METHOD OF GRAY-GREEN-BLUE MEASURES WITH DINGO OPTIMIZATION ALGORITHM COUPLED WITH SWMM

(71) Applicants: Hohai University, Nanjing (CN); Hebei Extension Center Of Water Resources Research And Hydrological Technology Experment, Shijiazhuang (CN)

(72) Inventors: Qinghua Luan, Nanjing (CN); Xiaoli Zhang, Nanjing (CN); Wang Lv, Nanjing (CN); Shuang Hou, Nanjing (CN); Cheng Gao, Nanjing (CN); Xiqing Liu, Nanjing (CN); Huayue Li, Nanjing (CN); Lei Xie, Nanjing (CN); Yunyun Zhao, Nanjing (CN)

(21) Appl. No.: 19/283,137

(22) Filed: Jul. 28, 2025

(30) Foreign Application Priority Data
May 8, 2025 (CN) 202510586632.9

(51) Int. Cl. G06F 30/28; E03F 1/00; G06F 17/11

(52) U.S. Cl. CPC G06F 30/28; G06F 17/11; E03F 1/00

(57) ABSTRACT

Provided is a multi-objective segmented optimization method of gray-green-blue measures with a dingo optimization algorithm coupled with SWMM, which relates to the technical field of urban waterlogging treatment. In the present disclosure, by analyzing waterlogging distribution, types, scales and cost of measures are determined, and an optimization model with minimization of total investment cost and maximization of a total runoff reduction rate as objectives are constructed. Decision variables include a pump station waterlogging drainage flow, and the like. The flow is analyzed by a period-by-period water flow regulation and storage calculation method, and relationships between variables are established through multivariate regression. In the first round, a dingo algorithm is used to generate a Pareto solution set, which is then optimized with an SWMM model to obtain a Pareto frontier solution set suitable for data-deficient areas. According to the present disclosure, urban resilience can be enhanced.

### CROSS-REFERENCE TO RELATED APPLICATION

This application claims priority of Chinese Patent Application No. 202510586632.9, filed on May 8, 2025, the entire contents of which are incorporated herein by reference.

### TECHNICAL FIELD

The present disclosure relates to the technical field of urban waterlogging treatment, and in particular, to a multi-objective segmented optimization method of gray-green-blue measures with a dingo optimization algorithm coupled with SWMM.

### BACKGROUND

In recent years, climate warming has led to changes in global precipitation patterns, rapid urbanization has changed the runoff infiltration process, and the mismatch in drainage system design has combined to make urban waterlogging a challenge that needs to be addressed globally. Gray-green-blue measures are particularly important for urban waterlogging treatment, but due to the complexity of the operating mechanism and the uncertainty of the synergistic effect, gray measures, especially pump stations, are not used as decision variables in traditional multi-objective optimization models. At present, the research on urban waterlogging drainage planning at the watershed scale lacks systematicity and has not fully considered the synergistic effects of pump station waterlogging drainage flow, regional water surface ratio and green measures layout rate on the runoff generation and convergence process. How to achieve the organic combination of gray-green-blue measures and quantify the synergy effect remains an urgent problem to be solved.

The gray-green-blue hybrid infrastructure framework involves multiple factors, and the effective allocation of resources is crucial under the complex multi-dimensional coupling relationship. The location and scale of green measures and regulation and storage pump stations should be rationally arranged to ensure maximum water management benefits. Therefore, how to determine the optimal ratio of gray, green and blue measures depends on the balance between multiple objectives. Integrated hydrological models and optimization algorithms are used to analyze the synergistic effect mechanism of gray-green-blue measures and find the optimal spatial combination solution. However, obtaining and processing various high-precision basic data required for rainfall flood models is also challenging.

### SUMMARY

In order to overcome the deficiencies of the existing technology, the present disclosure aims to provide a multi-objective segmented optimization method of gray-green-blue measures with a dingo optimization algorithm coupled with SWMM, which is suitable for both data-deficient areas and areas with modeling conditions. The present disclosure reduces constraint ranges of decision variables through a segmented optimization strategy and seeks an optimal spatial layout scheme. The present disclosure provides new ideas for optimizing waterlogging drainage in data-deficient areas, and at the same time provides better technical support for improving urban resilience.

To achieve the above objective, the present disclosure provides the following solutions:

A multi-objective segmented optimization method of gray-green-blue measures with a dingo optimization algorithm coupled with SWMM includes:
determining a waterlogging distribution status quo and simulation results according to basic data of a study area collected and collated, and determining types, scales, parameters and unit investment cost of gray-green-blue measures;
optimizing the types and layout of the gray-green-blue measures based on the waterlogging distribution status quo;
constructing a multi-objective optimization model, with minimization of total investment cost and maximization of a total runoff reduction rate as an objective function, and a pump station waterlogging drainage flow, a water surface ratio, a sunken green space ratio and a permeable pavement ratio as decision variables, setting constraint conditions by combining an area constraint, an effectiveness constraint and fitting relationships between the decision variables;
using a period-by-period water flow regulation and storage calculation method to analyze the pump station waterlogging drainage flow under different working conditions based on the gray-green-blue measures and the multi-objective optimization model, and establishing a mathematical relationship expression between the decision variables through multivariate regression analysis as an equality constraint;
performing a first iteration optimization on the multi-objective optimization model using with a dingo optimization algorithm to generate a Pareto solution set and decision variable ranges;
constructing an SWMM model based on the basic data, and using historical rainfall data to perform calibration and verification to ensure accuracy of the SWMM model; and
coupling the SWMM model with the dingo optimization algorithm, updating the objective function and the constraint conditions based on the decision variable ranges of the first optimization, performing second optimization to generate a Pareto frontier solution set of spatial layout of the gray-green-blue measures.

Preferably, the basic data includes: rainfall data, land use types, drainage network information, pump station parameters, elevation data and riverway water level data.

Preferably, optimizing the types and layout of the gray-green-blue measures based on the waterlogging distribution status quo includes:
laying regulation and storage pump stations near riverways and waterlogging-prone areas as gray measures;
according to construction suitability of the land use types, laying the sunken green space in ordinary green space areas, and rebuilding the permeable pavement in residential areas, commercial areas and road areas as green measures; and
taking expansion of the water surface ratio of the original riverways and lakes in the study area as blue measures.

Preferably, the decision variables of the multi-objective optimization model are:

$$X = \{ \begin{matrix}q \\ {p}_{i} ( i = 1 ∼ m ) \\ {x}_{j} ( j = 1 ∼ n )\end{matrix} \} ;$$

where, X represents a vector of the decision variable; q represents the flow of the waterlogging drainage pump station in the study area; pᵢ represents the water surface ratio of the i-th water body type; xⱼ represents the area ratio of the j-th green measure, m represents the number of water body types, and n represents the number of green measures;
calculation formulas of the objective function are:

$$\{ \begin{matrix}{f}_{1} = A \times q + {\sum }_{i = 1}^{m} F \times {B}_{i} \times ( {p}_{i} - {p}_{0 , i} ) \times {h}_{i} + {\sum }_{j = 1}^{n} {C}_{j} {x}_{j} \\ {f}_{2} = \frac{( {α}_{A} - α ) \times F \times P - q \times Δ t}{{α}_{A} \times F \times P} \times 100 \%\end{matrix} ;$$

where, f₁ represents the total investment cost, A is the sum of a present value of investment per unit flow of the waterlogging drainage pump station and a present value of operation and management; Bᵢ is the cost of excavating each cubic meter of the i-th water body type; hᵢ is the waterlogging depth of the i-th water body type; F is the area of the study area; P_{0,i} is the water surface ratio of the i-th status quo type; Cⱼ is the total of construction cost and maintenance and operation cost of the j-th LID measure type; f₂ represents the total runoff reduction rate; α_{A} is a runoff coefficient before implementation of any measure; α is the runoff coefficient after implementation of the blue-green measures, Δt is waterlogging drainage time of the pump station;
   expressions of the constraint conditions are:

$$\{ \begin{matrix}{p}_{i}^{*} \leq {p}_{i} \leq {p}_{max} \\ {x}_{i}^{*} \leq {x}_{i} \\ q \geq \frac{β \cdot 0.8 \cdot F \cdot P}{3.6 \cdot T} \\ q = f ( {p}_{i} , {x}_{j} )\end{matrix} ;$$

where,

$${P}_{i}^{*}$$

is a minimum water surface ratio of the i-th water body type;

$${x}_{i}^{*}$$

is a minimum layout area ratio of the i-th green measure type; P is the rainfall, β is the percentage of discharge flow of the pump station; T is designed waterlogging drainage duration.

Preferably, formulas of the period-by-period water flow regulation and storage calculation method are:

$$\{ \begin{matrix}{V}_{2} = {V}_{1} + \frac{{Q}_{1} + {Q}_{2}}{2} - q \times Δ t \\ {Q}_{1} = 0.8 \cdot {P}_{1} \cdot F - 0.01 \cdot {x}_{4} \cdot {F}_{green} \cdot \\ {P}_{1} - 0.01 \cdot {x}_{5} \cdot {F}_{harden} \cdot ( 1 - φ ) \cdot {P}_{1} \\ {Q}_{2} = 0.8 \cdot {P}_{2} \cdot F - 0.01 \cdot {x}_{4} \cdot {F}_{green} \cdot \\ {P}_{2} - 0.01 \cdot {x}_{5} \cdot {F}_{harden} \cdot ( 1 - φ ) \cdot {P}_{2}\end{matrix}$$

where, V₁ and V₂ are riverway water storage capacities at the beginning and end of a period respectively; Q₁ and Q₂ are inflow water flows at the beginning and end of the period respectively; P₁ and P₂ are the rainfalls in each period, and p is the rainfall runoff coefficient of the permeable pavement; Δt is the time interval between the beginning and the end of the period; F_{green} and F_{harden} are the areas of green space in the study area and hardened ground in the study area respectively.

Preferably, the dingo optimization algorithm includes:
initializing a population and generating random solutions;
evaluating fitness through non-dominated sorting and selecting the optimal solution;
simulating dingo hunting behaviors, including siege, pursuit, carrion eating and survival rules, and updating a solution position; and
iterating until a termination condition is met and outputting a Pareto solution set.

Preferably, constructing an SWMM model based on the basic data, and using historical rainfall data to perform calibration and verification to ensure accuracy of the SWMM model includes:
using ArcGIS to convert CAD files of different land use types in the study area into SHP files, dividing the study area into several sub-catchment areas taking into account elevation changes, land use types, street distribution, and gully pots in the study area, and dividing roads separately;
using the ArcGIS to split and merge drainage pipelines in the study area, dividing drainage zones according to north-south directions of a drainage main pipeline, exporting the SHP files, and converting the SHP files into inp files that can be recognized by SWMM through an inpPINS plug-in;
dividing parameters in the SWMM model into deterministic parameters and calibration parameters, wherein the deterministic parameters include the characteristic width, area, slope, permeable rate, pipe diameter of a pipe network, burial depth and gully pot depth of the sub-catchment area; wherein, the area of each sub-catchment area is counted through a “Calculate Geometry” function in the ArcGIS, and area proportions of the different land use types are calculated; elevation data is converted and calculated to obtain an average slope through 3D Analyst and Spatial Analyst functions; the calibration parameters are determined by referring to an SWMM model manual and parameter value ranges of the study area;
using a comprehensive runoff coefficient to preliminarily adjust model parameters of the SWMM model, selecting values according to parameters of different regions in an empirical range, and improving the accuracy of the SWMM model through multiple adjustments; and
using measured data of waterlogging during two historical rainfall events for calibration and verification, evenly distributing a maximum overflow of a simulated waterlogging-prone point over the road area, obtaining a simulated maximum surface waterlogging depth by calculation, calculating a relative error between the simulated value and the measured waterlogging depth to verify the accuracy of the SWMM model; a formula for the relative error is as follows:

$$error = \frac{{H}_{1} - {H}_{2}}{{H}_{1}} 100 \% ;$$

where, H₁ is the measured value of waterlogging at a monitoring point; H₂ is the simulated value of waterlogging at the monitoring point.

Preferably, coupling the SWMM model with the dingo optimization algorithm, updating the objective function and the constraint conditions based on the decision variable ranges of the first optimization, performing second optimization to generate a Pareto frontier solution set of spatial layout of the gray-green-blue measures include:
based on the ranges of decision variables under corresponding schemes of a Pareto frontier of the first optimization, updating a multi-objective optimization function with an average pump station waterlogging drainage flow and an average water surface ratio of all the schemes as known variables, and updating the constraint conditions with extreme values of the sunken green space ratio and the permeable pavement ratio;
constructing an optimization model of the updated multi-objective function through Python, and implementing iteration by the dingo optimization algorithm;
implementing automatic establishment of the SWMM model through Python, and coupling the dingo optimization algorithm to implement automatic optimization of sunken green space and permeable pavement layout area; and
based on the obtained optimization model of the multi-objective function, using the dingo optimization algorithm for iteration to obtain a Pareto frontier of the second optimization and determining a scheme solution set of spatial layout under green measures.

A multi-objective segmented optimization system of gray-green-blue measures with a dingo optimization algorithm coupled with SWMM includes:
a data collection unit configured to determine a waterlogging distribution status quo and simulation results according to basic data of a study area collected and collated, and determine types, scales, parameters and unit investment cost of gray-green-blue measures;
a measure optimization unit configured to optimize the types and layout of the gray-green-blue measures based on the waterlogging distribution status quo;
an objective construction unit configured to construct a multi-objective optimization model, with minimization of total investment cost and maximization of a total runoff reduction rate as an objective function, and a pump station waterlogging drainage flow, a water surface ratio, a sunken green space ratio and a permeable pavement ratio as decision variables, set constraint conditions by combining an area constraint, an effectiveness constraint and fitting relationships between the decision variables;
a multi-objective optimization unit configured to use a period-by-period water flow regulation and storage calculation method to analyze the pump station waterlogging drainage flow under different working conditions based on the gray-green-blue measures and the multi-objective optimization model, and establish a mathematical relationship expression between the decision variables through multivariate regression analysis as an equality constraint;
a first optimization unit configured to perform a first iteration optimization on the multi-objective optimization model with a dingo optimization algorithm to generate a Pareto solution set and decision variable ranges;
a model construction unit configured to construct an SWMM model based on the basic data, and use historical rainfall data to perform calibration and verification to ensure accuracy of the SWMM model; and
a second optimization unit configured to couple the SWMM model with the dingo optimization algorithm, update the objective function and the constraint conditions based on the decision variable ranges of the first optimization, and perform second optimization to generate a Pareto frontier solution set of spatial layout of the gray-green-blue measures.

According to the specific embodiments provided by the present disclosure, the present disclosure discloses the following technical effects:

The present disclosure fully considers the synergistic effect of the gray-green-blue measures, especially the runoff reduction and control effect of the pump station. Traditional models usually focus on a single waterlogging prevention measure, or take grey measures and water surface ratio as known conditions rather than decision variables of the model. The present disclosure creatively proposes a multi-objective segmented optimization model for urban waterlogging prevention and control that takes into account the pump station waterlogging drainage flow, water surface area, and LID measures. This segmented optimization strategy creatively solves the bottleneck of data acquisition and processing in hydrological models, which is suitable for data-deficient areas and areas with modeling conditions, expands the scope of application of the optimization model, provides new ideas for solving waterlogging drainage optimization in data-deficient areas, and provides better technical support for improving urban resilience.

### BRIEF DESCRIPTION OF DRAWINGS

In order to more clearly illustrate embodiments of the present disclosure or the technical solutions in the existing technology, the drawings required for use in the embodiments will be briefly introduced below. Obviously, the accompanying drawings described below are only some embodiments of the present disclosure. For those of ordinary skill in the art, other drawings can be obtained based on these accompanying drawings without paying creative labor.

FIG. 1 is a flowchart of steps provided by an embodiment of the present disclosure;

FIG. 2 is a schematic diagram of a technical route provided by an embodiment of the present disclosure;

FIG. 3 is a generalized schematic diagram of an SWMM model for a main urban area of a city provided by an embodiment of the present disclosure;

FIG. 4(a) is a diagram showing a simulated waterlogging depth and a measured waterlogging depth at a waterlogging point of a rainfall event on Jun. 26, 2022;

FIG. 4(b) is a diagram showing a simulated waterlogging depth and a measured waterlogging depth at a waterlogging point of a rainfall event on Jul. 5, 2022; and

FIG. 5 is a Pareto frontier set obtained by second optimization of a main urban area of a city provided by an embodiment of the present disclosure.

### DETAILED DESCRIPTION OF EMBODIMENTS

The technical solutions in embodiments of the present disclosure will be described clearly and completely below in conjunction with the drawings in the embodiments of the present disclosure. Obviously, the described embodiments are only part of the embodiments of the present disclosure, rather than all the embodiments. Based on the embodiments of the present disclosure, all other embodiments obtained by those of ordinary skill in the art without making any creative work shall fall within the scope of protection of the present disclosure.

The present disclosure aims to provide a multi-objective segmented optimization method of gray-green-blue measures with a dingo optimization algorithm coupled with SWMM, which takes into account the runoff reduction and control effect of pump stations, is suitable for data-deficient areas, and improves urban resilience.

In order to make the above-mentioned objectives, features and advantages of the present disclosure more obvious and easy to understand, the present disclosure is further described in detail below with reference to the accompanying drawings and specific embodiments.

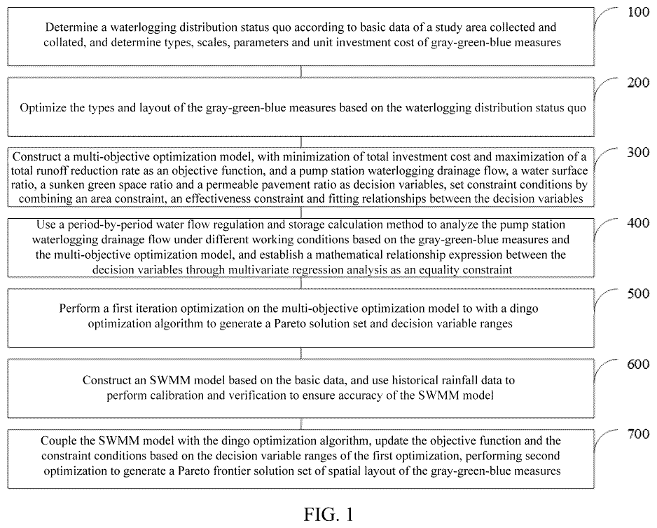

FIG. 1 is a flowchart of steps provided by an embodiment of the present disclosure. As shown in FIG. 1, the present disclosure provides a multi-objective segmented optimization method of gray-green-blue measures with a dingo optimization algorithm coupled with SWMM, which includes:
step 100: determining a waterlogging distribution status quo and simulation results according to basic data of a study area collected and collated, and determining types, scales, parameters and unit investment cost of gray-green-blue measures;
step 200: optimizing the types and layout of the gray-green-blue measures based on the waterlogging distribution status quo and the simulation results;
step 300: constructing a multi-objective optimization model, with minimization of total investment cost and maximization of a total runoff reduction rate as an objective function, and a pump station waterlogging drainage flow, a water surface ratio, a sunken green space ratio and a permeable pavement ratio as decision variables, setting constraint conditions by combining an area constraint, an effectiveness constraint and fitting relationships between the decision variables;
step 400: using a period-by-period water flow regulation and storage calculation method to analyze the pump station waterlogging drainage flow under different working conditions based on the gray-green-blue measures and the multi-objective optimization model, and establishing a mathematical relationship expression between the decision variables through multivariate regression analysis as an equality constraint;
step 500: performing a first iteration optimization on the multi-objective optimization model with a dingo optimization algorithm to generate a Pareto solution set and decision variable ranges;
step 600: constructing an SWMM model based on the basic data, and using historical rainfall data to perform calibration and verification to ensure accuracy of the SWMM model;
step 700: coupling the SWMM model with the dingo optimization algorithm, updating the objective function and the constraint conditions based on the decision variable ranges of the first optimization, performing second optimization to generate a Pareto frontier solution set of spatial layout of the gray-green-blue measures.

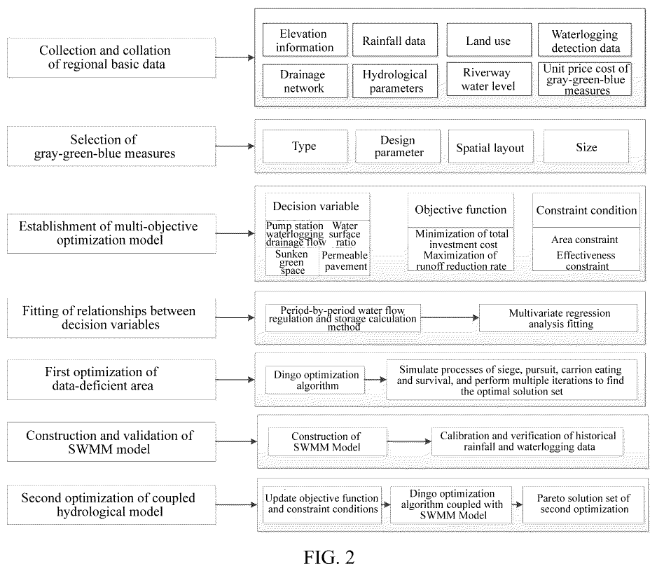

Specifically, as shown in FIG. 2, a multi-objective segmented optimization method of gray-green-blue measures with a dingo optimization algorithm coupled with SWMM in this embodiment includes:
Step 1: collection and collation of basic data and information of the study area, mainly including basic data such as rainfall, waterlogging distribution, elevation, drainage network, land use, riverway water level, and waterlogging drainage flows of existing pump stations required for construction of the SWMM model; performance of real-time monitoring of regional rainfall and waterlogging for obtaining the waterlogging distribution status quo. The scales, parameters and unit investment cost of various types of gray, green and blue measures are determined in combination with local realities and planning designs. Specifically: Going to intersections in the main urban area of the study area to perform waterlogging monitoring and record the waterlogging process and maximum waterlogging depth.
Step 2: selection of gray-green-blue measures; based on the regional waterlogging distribution status quo in step 1, the specific types, design parameters and layout of the gray-green-blue measure are determined.
Step 2.1: selection of appropriate gray-green-blue measures based on the planning and design of the study area. Pump stations are selected as grey measures to achieve rapid drainage, and locations and numbers of the pump stations are expanded and newly constructed according to the status quo of the study area. Regulation and storage pump stations are built near riverways and waterlogging-prone areas with severe waterlogging.
Step 2.2: green measures including sunken green space and permeable pavement; the layout area, location and design parameters of various green measures are determined according to the planning and design of the study area. Taking into account the differences in construction suitability of different green measures according to land use types and the difficulty of construction in old urban areas, the sunken green space is laid on ordinary green land, and permeable pavement is rebuilt in residential areas, commercial areas and road land.
Step 2.3: the water surface ratio in the study area is used to represent blue measures, which involves excavation and expansion on the original riverways and lakes in the study area.
Step 3: establishment of the multi-objective optimization model; based on the gray-green-blue measures selected in step 3, it is determined to construct a regional multi-objective optimization model with minimization of total investment cost and maximization of a total runoff reduction rate as an objective function of the study area, with a pump station waterlogging drainage flow, a lake water surface ratio, a riverway water surface ratio, a sunken green space ratio and a permeable pavement ratio as decision variables, and with an area constraint, an effectiveness constraint and fitting relationships between the decision variables as constrain conditions.
Step 3.1: based on the gray-green-blue measures selected in step 2, the decision variables are determined as follows:

$$X = \{ \begin{matrix}q \\ {p}_{i} ( i = 1 ∼ m ) \\ {x}_{j} ( j = 1 ∼ n )\end{matrix} \}$$

where, X represents a vector of the decision variable; q represents the flow of the waterlogging drainage pump station in the study area (m³/s); pᵢ represents the water surface ratio of the i-th water body type (lake, river); xⱼ represents the area ratio of the j-th green measure (sunken green space, permeable pavement).
Step 3.2: the gray-green-blue measures are optimized with minimization of total investment cost and maximization of a total runoff reduction rate as an objective function to seek a balance between economic and environmental benefits. Specific calculation formulas are as follows:

$$\{ \begin{matrix}{f}_{1} = A \times q + {\sum }_{i = 1}^{m} F \times {B}_{i} \times ( {p}_{i} - {p}_{0 , i} ) \times {h}_{i} + {\sum }_{j = 1}^{n} {C}_{j} {x}_{j} \\ {f}_{2} = \frac{( {α}_{A} - α ) \times F \times P - q \times Δ t}{{α}_{A} \times F \times P} \times 100 \%\end{matrix}$$

where, f₁ represents the total investment cost. A is the sum of a present value of investment per unit flow of the waterlogging drainage pump station and a present value of operation and management (*ten thousand yuan); Bᵢ is the cost of excavating each cubic meter of the i-th water body type (river, lake) (*ten thousand yuan); hᵢ is the waterlogging depth of the i-th water body type (river, lake) (m); F is the area of the study area; p_{0,i} is the water surface ratio of the i-th status quo type; Cj is the total of construction cost and maintenance and operation cost of the j-th LID measure Type; f₂ represents the total runoff reduction rate; α_{A} is a runoff coefficient before implementation of any measure; α is the runoff coefficient after implementation of the blue-green measures, and Δt is waterlogging drainage time of the pump station. The remaining symbols are the same as before.
Step 3.3: the constraint range of parameters mainly considers the area constraint and effectiveness constraint, and the maximum value of blue-green measures is determined according to the planning design and land use constraints of the study area; the minimum waterlogging drainage flow of the pump station is determined according to the objective of the discharge flow of the region. In addition, the water storage and infiltration effects of blue-green measures will affect the runoff production process, and the fitting relationship between the waterlogging drainage pump station and the water surface ratio and green measure rate needs to be used as a constraint condition. Formulas are as follows:

$$\{ \begin{matrix}{p}_{i}^{*} \leq {p}_{i} \leq {p}_{max} \\ {x}_{i}^{*} \leq {x}_{i} \\ q \geq \frac{β \cdot 0.8 \cdot F \cdot P}{3.6 \cdot T} \\ q = f ( {p}_{i} , {x}_{j} )\end{matrix}$$

where,

$${P}_{i}^{*}$$

is a minimum water surface ratio of the i-th water body type (in % of the total area of the planning area);

$${x}_{i}^{*}$$

is a minimum layout area ratio of the i-th green measure; p is the rainfall (mm), and β is the percentage of discharge flow of the pump station. Considering that part of the rainfall is consumed and stored by other facilities, 80% of the rainfall is used to calculate the runoff; T is designed waterlogging drainage duration (h). The remaining symbols are the same as before.
Step 4: fitting of decision variable relationships; based on the gray-green-blue measures selected in step 3 and the multi-objective optimization model established in step 4, the period-by-period water flow regulation and storage calculation method is used to calculate the drainage flow of the pump station corresponding to different water surface ratios and sunken green space ratios, and the multivariate regression analysis method is used to fit the mathematical relationship expressions between the decision variables as the equality constraint condition.
Step 4.1: during calculation of the drainage water regulation and storage in the planning area, the regulation and storage effects of various measures should be considered. The period-by-period regulation and storage calculation is carried out according to the normal water level, drainage start level, minimum control water level and maximum control water level of the riverway. Formulas are as follows:

$$\{ \begin{matrix}{V}_{2} = {V}_{1} + \frac{{Q}_{1} + {Q}_{2}}{2} - q \times Δ t \\ {Q}_{1} = 0.8 \cdot {P}_{1} \cdot F - 0.01 \cdot {x}_{4} \cdot {F}_{green} \cdot \\ {P}_{1} - 0.01 \cdot {x}_{5} \cdot {F}_{harden} \cdot ( 1 - φ ) \cdot {P}_{1} \\ {Q}_{2} = 0.8 \cdot {P}_{2} \cdot F - 0.01 \cdot {x}_{4} \cdot {F}_{green} \cdot \\ {P}_{2} - 0.01 \cdot {x}_{5} \cdot {F}_{harden} \cdot ( 1 - φ ) \cdot {P}_{2}\end{matrix}$$

where, V₁ and V₂ are riverway water storage capacities at the beginning and end of a period (m³); Q₁ and Q₂ are inflow water flows at the beginning and end of the period (m³); P₁ and P₂ are the rainfalls in each period, wherein considering that part of the rainwater is lost, 80% of the rainfall is taken to calculate the design rainfall (mm); φ is the rainfall runoff coefficient of the permeable pavement, which is generally 0.08~0.45 and is taken as 0.2; Δt is the time interval between the beginning and the end of the period (h); the remaining symbols have the same meanings as above.
Step 5: first optimization of data-deficient areas; based on the regional multi-objective optimization model obtained in step 4 and step 5, the dingo optimization algorithm is used for iterative calculation to obtain the Pareto frontier of the first optimization and ranges of the decision variables.
Step 5.1: Python is used to write the dingo optimization algorithm, the multi-objective function is defined based on steps 3 and 4, and a population is initialized to generate a set of random solutions.
Step 5.2: the fitness of each solution is evaluated, non-dominated sorting is performed according to the value of the objective function, and the optimal solution is selected.

fitness(i)={square root over ((fᵢ₁(t)−fval₁)²+(fᵢ₂(t)−fval₂)²)}
where, fᵢ₁(t) and fᵢ₂(t) are the values of the objective functions F and α substituted by the i-th searcher at the current iteration number.
Step 5.3: problem space is considered as predation space to simulate siege, pursuit, carrion eating and survival processes of dingoes hunting large prey, and the solution is iteratively improved by updating the rules. Formulas are as follows:
\textcircled{1} Siege: Multiple searchers approach the location of the prey, that is, searching is made towards our objective optimization location \vec{x_{*}} and a new location is obtained:

$${\vec{x}}_{i} ( t + 1 ) = {β}_{1} {\sum }_{k = 1}^{na} \frac{[ {\vec{φ}}_{k} ( t ) - {\vec{x}}_{i} ( t ) ]}{na} - {\vec{x}}_{*} ( t )$$

where, \vec{x}ᵢ(t+1) is the new location of the i-th searcher; na is a randomly generated integer in the interval

$$[ 2 , \frac{SizePop}{2} ] ;$$

SizePop is the initial population size; \vec{φ}ₖ(t) is the randomly generated dingo subgroup; \vec{x}ᵢ(t) is the searcher's current location; \vec{x}_{*}(t) is the global optimal individual in the previous iteration; β₁: A random scale factor within [−2,2], which changes the size and direction of the motion trajectory;
\vec{2} Pursuit: Preying on small prey, meaning searching near the global optimal location individual \vec{x_{*}}(t) of the current iteration number and obtaining a new location:

\vec{x}ᵢ(t+1)=\vec{x_{*}}(t)+β₁e^{β}^{₂}(\vec{x}ᵣ_{₁}(t)−\vec{x}ᵢ(t))
where, β₂ is a random number within [−1,1];
\textcircled{3} Carrion eating: The behavior of carrion discovery and eating during a random walk, i.e. choosing a new location between the current location and any of the searchers:

$${\vec{x}}_{i} ( t + 1 ) = \frac{1}{2} [ {e}^{{β}_{2}} {\vec{x}}_{{r}_{1}} ( t ) - {( - 1 )}^{σ} * {\vec{x}}_{i} ( t ) ]$$

where, r₁ and r₂ are two randomly selected searchers, i≠r₁, r₁≠r₂;
\textcircled{4} Survival: the survival probability of each dingo is calculated. When the survival probability is less than a certain value, it needs to move to the vicinity of the global optimal individual \vec{x_{*}}(t) and update the “leader”, that is, the global optimal individual location \vec{x_{*}}(t+1), according to the new fitness function value;

$$survival ( i ) = \frac{{fitness}_{max}}{fitness {min}_{max}}$$

$${\vec{x}}_{i} ( t ) = {\vec{x}}_{*} ( t ) + \frac{1}{2} [ {\vec{x}}_{{r}_{1}} ( t ) - {( - 1 )}^{σ} * {\vec{x}}_{{r}_{2}} ( t ) ]$$

where, σ is a binary number of 0 or 1;
Step 5.4: step 5.3 is repeated until the iteration termination condition is met; multiple iterations are performed to obtain the Pareto frontier of the first optimization and the ranges of decision variables.
Step 6: construction and verification of the SWMM model; the SWMM model is constructed based on the data in step 1, and calibrated and verified using data of two historical rainfall events.
Step 6.1: using ArcGIS to convert CAD files of different land use types in the study area into SHP files according to different layers, dividing the study area into several sub-catchment areas taking into account elevation changes, land use types, street distribution, and gully pots in the study area, and dividing roads separately.
Step 6.2: using the ArcGIS to reasonably split and merge drainage pipelines in the study area, dividing drainage zones according to north-south directions of a drainage main pipeline, exporting the SHP files, and converting the SHP files into inp files that can be recognized by SWMM through an inpPINS plug-in.
Step 6.3: parameters in the model are divided into deterministic parameters and calibrated parameters. Deterministic parameters include the characteristic width, area, slope, permeable rate, pipe diameter of a pipe network, burial depth and gully pot depth of the sub-catchment area. The area of each sub-catchment area is counted through a “Calculate Geometry” function in the ArcGIS, and area proportions of the different land use types are calculated. Elevation data can be converted and calculated to obtain an average slope through 3D Analyst and Spatial Analyst functions, while other parameters are obtained based on the regional planning and design data. Calibration parameters such as Manning coefficient, infiltration rate, and depression storage capacity of the catchment area need to be determined based on experience in reference to an SWMM model manual and the parameter value range of the study area.
Step 6.4: using a comprehensive runoff coefficient to preliminarily adjust model parameters of the SWMM model, selecting values according to parameters of different regions in an empirical range, and improving the accuracy of the SWMM model through multiple adjustments; and using measured data of waterlogging during two historical rainfall events for calibration and verification, evenly distributing a maximum overflow of a simulated waterlogging-prone point over the road area, obtaining a simulated maximum surface waterlogging depth by calculation, calculating a relative error between the simulated value and the measured waterlogging depth to verify the accuracy of the model. The formula is as follows:

$$Error = \frac{{H}_{1} - {H}_{2}}{{H}_{1}} 100 \%$$

where, H₁ is the measured value of waterlogging at a monitoring point, cm; H₂ is the simulated value of waterlogging at the monitoring point, cm.
Step 7: coupling of the dingo optimization algorithm with the SWMM model; based on the Pareto frontier of the first optimization and the ranges of decision variables obtained in step 5, the mean values of the waterlogging drainage flow and water surface ratio of the pump station are taken as known variables, and extreme values of the sunken green space ratio and the permeable pavement ratio are used to update the objective functions and the ranges of decision variables. Through Python programming, the SWMM model is automatically established, run and analyzed, and the dingo optimization algorithm is coupled to implement the automatic optimization of the sunken green space and permeable pavement layout area, and a Pareto frontier of the second optimization is obtained as a scheme solution set for the spatial layout of gray-green-blue measures.
Step 7.1: based on the ranges of decision variables under corresponding schemes of the Pareto frontier of the first optimization obtained in steps 4 and 5, an average pump station waterlogging drainage flow and an average water surface ratio of all schemes are used as known variables to update the multi-objective optimization function, and the constraints are updated with extreme values of the sunken green space ratio and the permeable pavement ratio.
Step 7.2: constructing an optimization model of the updated multi-objective function through Python, and implementing iteration by the dingo optimization algorithm.
Step 7.3: implementing automatic establishment of the SWMM model through Python, and coupling the dingo optimization algorithm to implement automatic optimization of sunken green space and permeable pavement layout area. At this time, the model calculates the surface runoff, and compares it with the surface runoff volume before implementation of any measure to obtain the total runoff reduction rate.
Step 7.4: based on step 7.2 and step 7.3, constructing the multi-objective optimization model, and using the dingo optimization algorithm for iteration to obtain the Pareto frontier of the second optimization and the scheme solution set of the spatial layout under the green measures.

### EMBODIMENT

The optimization method of the present disclosure is applied to the main urban area of Handan City, Hebei Province, and the technical process includes:

Collection and compilation of basic data and information of the study area, selection of grey-green-blue measures, establishment of a multi-objective optimization model, fitting of decision variable relationships, first optimization in data-deficient areas, construction and verification of an SWMM model, coupling of a dingo optimization algorithm with the SWMM model. The specific process is as follows:
(1) Collection and collation of relevant basic data of the study area, including land use, once-in-20-year design rainfall, unit cost of gray-green-blue measures, unit price of green measures, etc. Among them, land use data includes the area of the study area and the area proportion of each land use type. The study area covers an area of about 24.204 km², of which 2.2% is riverway surface, 0.3% is lake surface, and the average waterlogging depth of the main river is about 3.16 m. Land use types include 12.63% roads, 40.14% residential areas, 18.82% green space, 22.66% commercial areas, and 3.26% industrial land.
(2) Drainage zones within the study area are relatively independent, and ends of drainage networks are connected to the Qin River and the Fuyang River. Outlets of existing gravity-flowing rainwater pipes are mostly close to the riverbed, resulting in a slow flow rate in the pipes. River water backflow is prone to occur during flood seasons. Therefore, this embodiment considers new construction and reconstruction of 5 forced drainage pump stations along the river as a gray measure, and widening of the river and lake surfaces as a blue measure. Taking into account the differences in construction suitability of different green measures according to land use types and the difficulty of construction in old urban areas, the embodiment chooses to lay sunken green space on ordinary green land, and to rebuild permeable pavements in residential areas, commercial areas and road land.
(3) Taking minimization of total investment cost and maximization of a total runoff reduction rate as an objective function of the study area, a balance between economic and environmental benefits is sought. The total investment cost mainly includes annual infrastructure costs and management and maintenance costs. The unit costs of various measures obtained by referring to relevant literature and Handan City Construction Plan and other materials are shown in Table 1. The annual runoff reduction rate is based on the ratio of the sum of the pump station discharge flow and the reduction due to blue-green measures to the surface runoff before implementation of any measure. Formulas of the multi-objective function are as follows:

$$\{ \begin{matrix}{f}_{1} = 50 q + 91781.57 {p}_{1} + 10707.85 {p}_{2} + \\ 24363.9 {x}_{1} + 205696.8 {x}_{2} - 2952.31 \\ {f}_{2} = 0.0147 - 0.585 {p}_{1} - 0.585 {p}_{2} + 0.024 {x}_{1} + 0.49 {x}_{2} + 0.015 q\end{matrix}$$

where, f₁ represents the total investment cost, and f₂ represents the total runoff reduction rate. q represents the flow (m³/s) of the waterlogging drainage pump station in the study area; p₁ and p₂ represent the water surface ratios of lakes and rivers, respectively; x₁ and x₂ represent the area ratios of sunken green space (in % of the green space in the study area) and permeable pavement.

TABLE 1
Basic costs and operation and management expenses
corresponding to different measures

| | | Waterlogging | | | |
|---|---|---|---|---|---|
| | | drainage | Excavation of | Sunken | |
| | | pump | riverways and | green | Permeable |
| Life cycle costs | institution | station/m³ | lakes/m³ | space/m² | pavement/m² |
| Infrastructure costs | yuan | 400000 | 12 | 50 | 100 |
| Management | yuan | 100000 | 20 | 5 | 8 |
| operation and | | | | | |
| maintenance costs | | | | | |
| Life cycle | year | 20 | 50 | 15 | 10 |

With reference to the planning and design of the study area, the minimum waterlogging drainage flow of the pump station is calculated with the goal of discharging 40% of the flood volume within 24 hours through runoff generated by rainfall, while the water surface ratio and green measures are mainly constrained by the area. To ensure that the study area has a significant runoff reduction effect, the minimum water surface ratio is set to the existing water surface ratio; referring to the relevant indicators of other sponge city pilot projects, the proportion of sunken green space is set to be no less than 30% (in % of the green space area in the planned area), and the permeable pavement ratio is set to be no less than 10% (in % of the hardened area in the planned area). The maximum values of various parameters are limited by the area of the study area. After collation, constraint condition formulas of the decision variables are as follows:

$$\{ \begin{matrix}q \geq 15.19 {m}^{3} / s \\ 0.3 \% \leq {p}_{1} \leq 3 \% , 2.2 \% \leq {p}_{2} \leq 5 \% , \\ 30 \% \leq {x}_{1} \leq 70 \% , \\ 10 \% \leq {x}_{2} \leq 26.4 \%\end{matrix}$$

(4) Period-by-period water flow regulation and storage calculation is used to obtain the discharge flow of the pump station corresponding to different water surface ratios, sunken green space and permeable pavement ratios. The initially set river pre-drainage level in this embodiment area is 3.4 m, and the highest water surface line of the middle and lower reaches of the river network area is controlled within 5.1 m. It is believed that the waterlogging drainage flow of the pump station obtained at this time is relatively reasonable. After rainfall, pumping machines are turned on to control the water level of the inland river between the highest and lowest control water levels. To ensure that the regulation and storage capacity in the dike is emptied in time and to prevent the next rainstorm and flooding, all the flood water stored in rivers and ponds must be discharged on the same day, and the riverway returns to its normal water level before the rain. The minimum waterlogging drainage flow is calculated accordingly. According to the basic data of Handan main urban area and the constraint conditions in the mathematical model, the approximate operating range of the water surface ratio, sunken green space ratio and permeable pavement ratio is determined. The calculation results of the waterlogging drainage flow under different water surface ratios (2.5%-5%), sunken green space ratios (30%-70%) and permeable pavement ratios (10%-26.4%) are shown in Table 2. Fitting relationship formulas between parameters obtained by multivariate regression analysis are as follows:

$$\{ \begin{matrix}q = 8153.517 {( {p}_{1} + {p}_{2} )}^{2} + 1.563 {x}_{1}^{2} + \\ 13.713 {x}_{2}^{2} + 202.288 ( {p}_{1} + {p}_{2} ) {x}_{1} + \\ 678.065 ( {p}_{1} + {p}_{2} ) {x}_{2} + 8.918 {x}_{1} {x}_{2} - 1882.806 ( {p}_{1} + \\ {p}_{2} ) - 37.515 {x}_{1} - 124.302 {x}_{2} + 136.173 \\ ( {R}^{2} = 0.996 )\end{matrix}$$

TABLE 2
Pump station waterlogging drainage flows corresponding
to different water surface ratios, sunken green
space ratios and permeable pavement

| Permeable | Water | | | | | |
|---|---|---|---|---|---|---|
| pavement | surface | Sunken green space ratio/% | | | | |
| ratio/% | ratio/% | 30 | 40 | 50 | 60 | 70 |
| 15 | 2.5% | 68.9 | 66.0 | 63.2 | 60.4 | 57.5 |
| | 3% | 62.9 | 60.0 | 57.1 | 54.2 | 51.4 |
| | 4% | 51.5 | 48.8 | 46.0 | 43.4 | 40.7 |
| | 5% | 41.5 | 39.0 | 36.5 | 34.0 | 31.7 |
| 19 | 2.5% | 65.1 | 62.3 | 59.4 | 56.5 | 53.6 |
| | 3% | 59.1 | 56.2 | 53.2 | 50.5 | 47.6 |
| | 4% | 47.8 | 45.1 | 42.5 | 39.9 | 37.2 |
| | 5% | 38.2 | 35.7 | 33.2 | 30.8 | 28.5 |
| 23 | 2.5% | 61.2 | 58.4 | 55.5 | 52.6 | 49.7 |
| | 3% | 55.2 | 52.4 | 49.5 | 46.7 | 44.0 |
| | 4% | 44.2 | 41.6 | 39.0 | 36.3 | 33.8 |
| | 5% | 34.8 | 32.4 | 30.0 | 27.7 | 25.5 |
| 26 | 2.5% | 58.3 | 55.4 | 52.5 | 49.7 | 46.9 |
| | 3% | 52.4 | 49.6 | 46.7 | 44.0 | 41.2 |
| | 4% | 41.6 | 39.0 | 36.3 | 33.8 | 31.3 |
| | 5% | 32.4 | 30.0 | 27.7 | 25.5 | 23.3 |

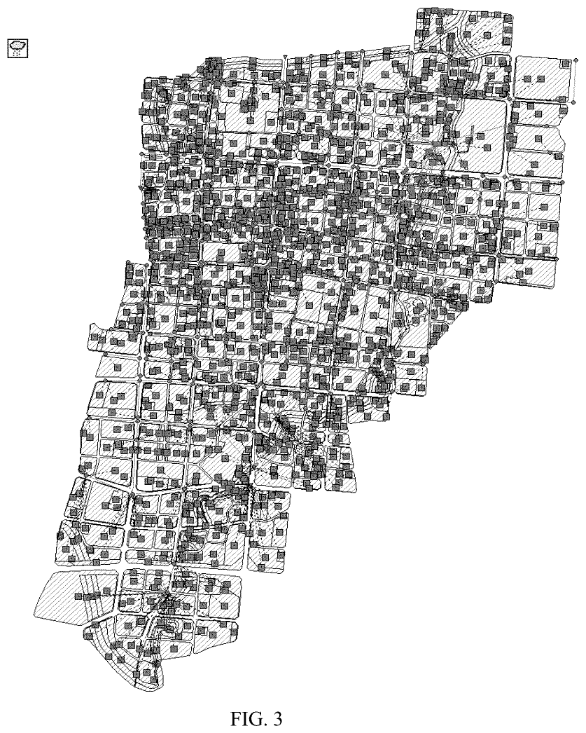

(5) The dingo optimization algorithm is used to iterate the multi-objective function optimization model to obtain the Pareto solution set of the first optimization and the corresponding decision variable ranges. According to the Pareto solution set, the cost is between 293.72 million yuan and 431.74 million yuan, but the reduction rate is between 44.24% and 44.2%. According to the distribution of decision variables, the waterlogging drainage flow of the pump station ranges from 18.18 to 28.08 m³/s, the lake ratio and water surface ratio range from 2.63% to 2.79% and 4.5% to 4.7% respectively, the sunken green space ratio ranges from 31.6% to 69% (in % of the green space), and the permeable pavement ratio ranges from 10% to 12.4%. Considering that the flow of the waterlogging drainage pump station is evenly distributed, the water surface ratio is concentrated, and the control is relatively complex in the SWMM model in the second stage of optimization, the average values of 23%, 2.7%, and 4.65% are selected as fixed values, respectively.
(6) For the data required by a high-precision hydrological model, the SWMM model can be further coupled to perform second optimization of spatial layout of green measures. The high-precision data required to build a hydrological model include elevation information, land use type and area, drainage network, historical rainfall data, waterlogging monitoring data, etc. Based on the above data, the study area is divided into 5 drainage zones, 1519 sub-catchment areas, 282 nodes, 282 pipelines, and 24 drainage outlets, as shown in FIG. 3.

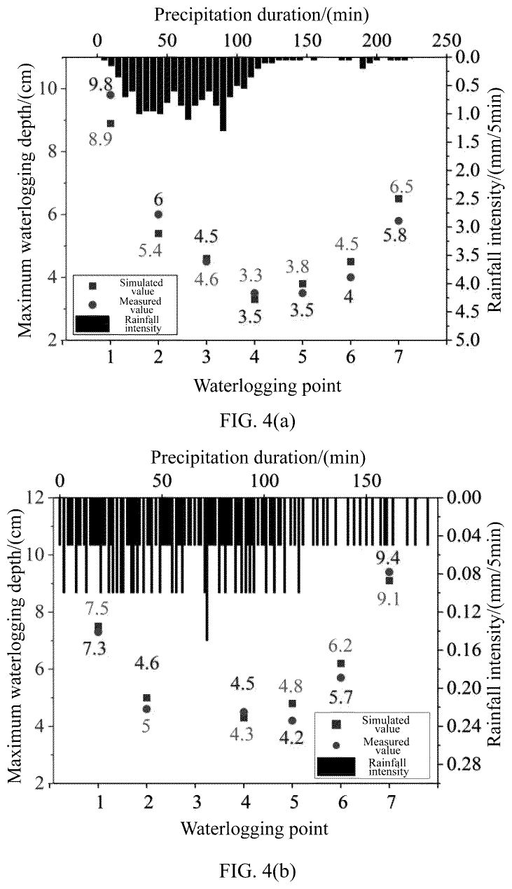

There are two types of parameters in the model: deterministic parameters and empirical parameters. Deterministic parameters can be calculated or extracted directly, while empirical parameters require reference to relevant literature and empirical values determined by standards. This embodiment uses a comprehensive runoff coefficient method to preliminarily determine the value range of the empirical parameters, and then uses the absolute errors between the simulated waterlogging depth and the measured waterlogging depth of waterlogging points of the two rainfall events on Jun. 26, 2022 and Jul. 5, 2022 for calibration and verification. The errors are all within 20%, as shown in FIG. 4(a) and FIG. 4(b), indicating that the simulation effect of the model is good. The final values of the calibration parameters are shown in Table 3.

TABLE 3
Values of SWMM model calibration parameters

| Parameters to be | | | | | | |
|---|---|---|---|---|---|---|
| calibrated | Value range | 1st | 2nd | 3rd | 4th | 5th |
| Width-K | 0.2~5 | 0.7 | 2.3 | 2.3 | 2.3 | 2.3 |
| N-Imperv | 0.011~0.015 | 0.013 | 0.011 | 0.011 | 0.014 | 0.014 |
| N-Perv | 0.05~0.8 | 0.1 | 0.13 | 0.1 | 0.1 | 0.13 |
| Roughness | 0~3 | 0.01 | 0.01 | 0.01 | 0.01 | 0.01 |
| D-Imperv | 3~10 | 0.04 | 0.04 | 0.04 | 0.04 | 0.04 |
| D-perv | 0.011~0.024 | 0.013 | 0.013 | 0.013 | 0.013 | 0.013 |
| Max Rate | 10~100 | 35 | 35 | 35 | 35 | 35 |
| Min Rate | 0~10 | 15 | 15 | 15 | 15 | 15 |
| Decay constant | 0~7 | 3 | 3 | 4 | 4 | 4 |
| Drying time | 1~7 | 7 | 7 | 7 | 7 | 7 |
| Simulated runoff | — | 0.6428 | 0.6436 | 0.64357 | 0.64351 | 0.64351 |
| coefficient | | | | | | |
| Comprehensive | 0.643 | | | | | |
| runoff coefficient | | | | | | |

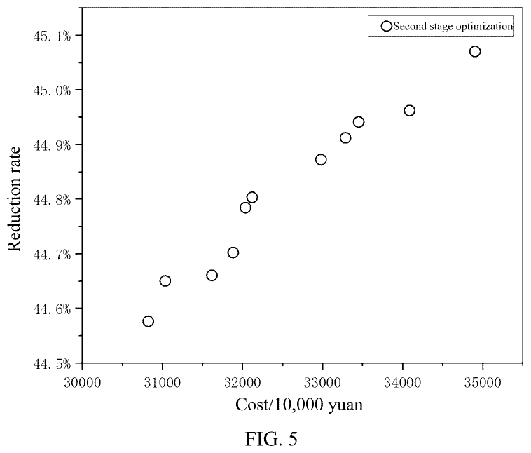

(7) The objective function and constraints are updated according to the first optimization result, and obtain the following formulas:

$$\{ \begin{matrix}{f}_{3} = 24363.9 {x}_{1} + 205696.8 {x}_{2} + 2617.2 \\ {f}_{4} = \frac{{S}_{A} - S}{{S}_{A}}\end{matrix}$$

where, f₃ represents the total investment cost based on the first optimization update. f₄ represents the total runoff reduction rate based on the first optimization update; S is the surface runoff (m³) obtained from the second optimization, and S_{A} is the surface runoff (m³) without any measures. LTD parameters need to be set in inp files, and the specific values are based on the experience of the study area. A PySWMM library is called to realize the automatic establishment, operation and analysis of the SWMM model through Python programming. The DOA optimization algorithm is coupled to realize the automatic optimization of the layout area of different LTD measures, and the solution set of the optimal spatial layout of green measures after the second optimization in the study area is obtained. In the second phase of optimization, as the cost increases from RMB 308 million to RMB 345 million, the reduction rate increases from 44.5% to 45.1%, as shown in FIG. 5.

The various embodiments in this specification are described in a progressive manner, and each embodiment focuses on the differences from other embodiments. The same or similar parts between the various embodiments can be referenced to each other.

This article uses specific examples to illustrate the principles and implementation methods of the present disclosure. The description of the above embodiments is only used to help understand the method and core ideas of the present disclosure; at the same time, for those of ordinary skill in the art, according to the concept of the present disclosure, there may be changes in the specific implementation methods and application scopes. In summary, the contents of this specification should not be understood as limiting the present disclosure.

1. A multi-objective segmented optimization method of gray-green-blue measures with a dingo optimization algorithm coupled with SWMM, comprising:
determining a waterlogging distribution status quo according to basic data of a study area collected and collated, and determining types, scales, parameters and unit investment cost of gray-green-blue measures;
optimizing the types and layout of the gray-green-blue measures based on the waterlogging distribution status quo;
constructing a multi-objective optimization model, with minimization of total investment cost and maximization of a total runoff reduction rate as an objective function, and a pump station waterlogging drainage flow, a water surface ratio, a sunken green space ratio and a permeable pavement ratio as decision variables, setting constraint conditions by combining an area constraint, an effectiveness constraint and fitting relationships between the decision variables;
using a period-by-period water flow regulation and storage calculation method to analyze the pump station waterlogging drainage flow under different working conditions based on the gray-green-blue measures and the multi-objective optimization model, and establishing a mathematical relationship expression between the decision variables through multivariate regression analysis as an equality constraint;
performing a first iteration optimization on the multi-objective optimization model with a dingo optimization algorithm to generate a Pareto solution set and decision variable ranges;
constructing an SWMM model based on the basic data, and using historical rainfall data to perform calibration and verification to ensure accuracy of the SWMM model; and
coupling the SWMM model with the dingo optimization algorithm, updating the objective function and the constraint conditions based on the decision variable ranges of the first optimization, performing second optimization to generate a Pareto frontier solution set of spatial layout of the gray-green-blue measures;
wherein coupling the SWMM model with the dingo optimization algorithm, updating the objective function and the constraint conditions based on the decision variable ranges of the first optimization, performing second optimization to generate a Pareto frontier solution set of spatial layout of the gray-green-blue measures comprises:
based on the ranges of decision variables under corresponding schemes of a Pareto frontier of the first optimization, updating a multi-objective optimization function with an average pump station waterlogging drainage flow and an average water surface ratio of all the schemes as known variables, and updating the constraint conditions with extreme values of the sunken green space ratio and the permeable pavement ratio;
constructing an optimization model of the updated multi-objective function through Python, and implementing iteration by the dingo optimization algorithm;
implementing automatic establishment of the SWMM model through Python, and coupling the dingo optimization algorithm to implement automatic optimization of sunken green space and permeable pavement layout area; and
based on the obtained optimization model of the multi-objective function, using the dingo optimization algorithm for iteration to obtain a Pareto frontier of the second optimization and determining a scheme solution set of spatial layout under green measures.

2. The multi-objective segmented optimization method of gray-green-blue measures with a dingo optimization algorithm coupled with SWMM according to claim 1, wherein the basic data comprises: rainfall data, land use types, drainage network information, pump station parameters, elevation data and riverway water level data.

3. The multi-objective segmented optimization method of gray-green-blue measures with a dingo optimization algorithm coupled with SWMM according to claim 1, wherein optimizing the types and layout of the gray-green-blue measures based on the waterlogging distribution status quo comprises:
laying regulation and storage pump stations near riverways and waterlogging-prone areas as gray measures;
according to construction suitability of the land use types, laying the sunken green space in ordinary green space areas, and rebuilding the permeable pavement in residential areas, commercial areas and road areas as green measures; and
taking expansion of the water surface ratio of the original riverways and lakes in the study area as blue measures.

4. The multi-objective segmented optimization method of gray-green-blue measures with a dingo optimization algorithm coupled with SWMM according to claim 1, wherein the decision variables of the multi-objective optimization model are:
$$X = \{ \begin{matrix}q \\ {p}_{i} ( i = 1 ∼ m ) \\ {x}_{j} ( j = 1 ∼ n )\end{matrix} \} ;$$
wherein X represents a vector of the decision variable; q represents the flow of the waterlogging drainage pump station in the study area; pᵢ represents the water surface ratio of the i-th water body type; xⱼ represents the area ratio of the j-th green measure, m represents the number of water body types, and n represents the number of green measures;
wherein calculation formulas of the objective function are:
$$\{ \begin{matrix}{f}_{1} = A \times q + {\sum }_{i = 1}^{m} F \times {B}_{i} \times ( {p}_{i} - {p}_{0 , i} ) \times {h}_{i} + {\sum }_{j = 1}^{n} {C}_{j} {x}_{j} \\ {f}_{2} = \frac{( {α}_{A} - α ) \times F \times P - q \times Δ t}{{α}_{A} \times F \times P} \times 100 \%\end{matrix} ;$$
wherein f₁ represents the total investment cost, A is the sum of a present value of investment per unit flow of the waterlogging drainage pump station and a present value of operation and management; Bᵢ is the cost of excavating each cubic meter of the i-th water body type; hᵢ is the waterlogging depth of the i-th water body type; F is the area of the study area; P_{0,i} is the water surface ratio of the i-th status quo type; Cⱼ is the total of construction cost and maintenance and operation cost of the j-th LID measure type; f₂ represents the total runoff reduction rate; α_{A} is a runoff coefficient before implementation of any measure; α is the runoff coefficient after implementation of the blue-green measures, Δt is waterlogging drainage time of the pump station; and
wherein expressions of the constraint conditions are:
$$\{ \begin{matrix}{p}_{i}^{*} \leq {p}_{i} \leq {p}_{max} \\ {x}_{i}^{*} \leq {x}_{i} \\ q \geq \frac{β \cdot 0.8 \cdot F \cdot P}{3.6 \cdot T} \\ q = f ( {p}_{i} , {x}_{j} )\end{matrix} ;$$
wherein
$${P}_{i}^{*}$$
is a minimum water surface ratio of the i-th water body type;
$${x}_{i}^{*}$$
is a minimum layout area ratio of the i-th green measure type; P is the rainfall, β is the percentage of discharge flow of the pump station; T is designed waterlogging drainage duration.

5. The multi-objective segmented optimization method of gray-green-blue measures with a dingo optimization algorithm coupled with SWMM according to claim 4, wherein formulas of the period-by-period water flow regulation and storage calculation method are:
$$\{ \begin{matrix}{V}_{2} = {V}_{1} + \frac{{Q}_{1} + {Q}_{2}}{2} - q \times Δ t \\ {Q}_{1} = 0.8 \cdot {P}_{1} \cdot F - 0.01 \cdot {x}_{4} \cdot {F}_{green} \cdot {P}_{1} - \\ 0.01 \cdot {x}_{5} \cdot {F}_{harden} \cdot ( 1 - φ ) \cdot {P}_{1} \\ {Q}_{2} = 0.8 \cdot {P}_{2} \cdot F - 0.01 \cdot {x}_{4} \cdot {F}_{green} \cdot {P}_{2} - \\ 0.01 \cdot {x}_{5} \cdot {F}_{harden} \cdot ( 1 - φ ) \cdot {P}_{2}\end{matrix}$$
wherein V₁ and V₂ are riverway water storage capacities at the beginning and end of a period respectively; Q₁ and Q₂ are inflow water flows at the beginning and end of the period respectively; P₁ and P₂ are the rainfalls in each period, and φ is the rainfall runoff coefficient of the permeable pavement; F_{green} and F_{harden} are the areas of green space in the study area and hardened ground in the study area respectively.

6. The multi-objective segmented optimization method of gray-green-blue measures with a dingo optimization algorithm coupled with SWMM according to claim 1, wherein the dingo optimization algorithm comprises:
initializing a population and generating random solutions;
evaluating fitness through non-dominated sorting and selecting the optimal solution;
simulating dingo hunting behaviors, including siege, pursuit, carrion eating and survival rules, and updating a solution position;
iterating until a termination condition is met and outputting a Pareto solution set.

7. The multi-objective segmented optimization method of gray-green-blue measures with a dingo optimization algorithm coupled with SWMM according to claim 1, wherein constructing an SWMM model based on the basic data, and using historical rainfall data to perform calibration and verification to ensure accuracy of the SWMM model comprises:
using ArcGIS to convert CAD files of different land use types in the study area into SHP files, dividing the study area into several sub-catchment areas taking into account elevation changes, land use types, street distribution, and gully pots in the study area, and dividing roads separately;
using the ArcGIS to split and merge drainage pipelines in the study area, dividing drainage zones according to north-south directions of a drainage main pipeline, exporting the SHP files, and converting the SHP files into inp files that can be recognized by SWMM through an inpPINS plug-in;
dividing parameters in the SWMM model into deterministic parameters and calibration parameters, wherein the deterministic parameters comprise the characteristic width, area, slope, permeable rate, pipe diameter of a pipe network, burial depth and gully pot depth of the sub-catchment area; wherein the area of each sub-catchment area is counted through a “Calculate Geometry” function in the ArcGIS, and area proportions of the different land use types are calculated; elevation data is converted and calculated to obtain an average slope through 3D Analyst and Spatial Analyst functions; the calibration parameters are determined by referring to an SWMM model manual and parameter value ranges of the study area;
using a comprehensive runoff coefficient to preliminarily adjust model parameters of the SWMM model, selecting values according to parameters of different regions in an empirical range, and improving the accuracy of the SWMM model through multiple adjustments; and
using measured data of waterlogging during two historical rainfall events for calibration and verification, evenly distributing a maximum overflow of a simulated waterlogging-prone point over the road area, obtaining a simulated maximum surface waterlogging depth by calculation, calculating a relative error between the simulated value and the measured waterlogging depth to verify the accuracy of the SWMM model; a formula for the relative error is as follows:
$$error = \frac{{H}_{1} - {H}_{2}}{{H}_{1}} 100 \% ;$$
wherein H₁ is the measured value of waterlogging at a monitoring point; H₂ is the simulated value of waterlogging at the monitoring point.

8. A multi-objective segmented optimization system of gray-green-blue measures with a dingo optimization algorithm coupled with SWMM, comprising:
a data collection unit configured to determine a waterlogging distribution status quo and simulation results according to basic data of a study area collected and collated, and determining types, scales, parameters and unit investment cost of gray-green-blue measures;
a measure optimization unit configured to optimize the types and layout of the gray-green-blue measures based on the waterlogging distribution status quo;
an objective construction unit configured to construct a multi-objective optimization model, with minimization of total investment cost and maximization of a total runoff reduction rate as an objective function, and a pump station waterlogging drainage flow, a water surface ratio, a sunken green space ratio and a permeable pavement ratio as decision variables, setting constraint conditions by combining an area constraint, an effectiveness constraint and fitting relationships between the decision variables;
a multi-objective optimization unit configured to use a period-by-period water flow regulation and storage calculation method to analyze the pump station waterlogging drainage flow under different working conditions based on the gray-green-blue measures and the multi-objective optimization model, and establishing a mathematical relationship expression between the decision variables through multivariate regression analysis as an equality constraint;
a first optimization unit configured to perform first iteration optimization on the multi-objective optimization model with a dingo optimization algorithm to generate a Pareto solution set and decision variable ranges;
a model construction unit, used for constructing an SWMM model based on the basic data, and using historical rainfall data to perform calibration and verification to ensure accuracy of the SWMM model;
a second optimization unit configured to couple the SWMM model with the dingo optimization algorithm, updating the objective function and the constraint conditions based on the decision variable ranges of the first optimization, performing second optimization to generate a Pareto frontier solution set of spatial layout of the gray-green-blue measures;
wherein implementation steps of the second optimization unit comprise:
based on the ranges of decision variables under corresponding schemes of a Pareto frontier of the first optimization, updating a multi-objective optimization function with an average pump station waterlogging drainage flow and an average water surface ratio of all the schemes as known variables, and updating the constraint conditions with extreme values of the sunken green space ratio and the permeable pavement ratio;
constructing an optimization model of the updated multi-objective function through Python, and implementing iteration by the dingo optimization algorithm;
implementing automatic establishment of the SWMM model through Python, and coupling the dingo optimization algorithm to implement automatic optimization of sunken green space and permeable pavement layout area; and
based on the obtained optimization model of the multi-objective function, using the dingo optimization algorithm for iteration to obtain a Pareto frontier of the second optimization and determining a scheme solution set of spatial layout under green measures.
